(19) United States
(12) Patent Application Publication
(10) Pub. No.: US 2003/0088045 A1
(43) Pub. Date: May 8, 2003

(54) Use of aqueous polyurethane dispersions in formulations for crack sealing coating systems

(76) Inventors: Hans Haberle, Gottmadingen (DE); Werner Temme, Bietingen (DE); Ralph Bergs, Hilzingen (DE); Norbert Steidl, Radolfszell (DE); Alois Maier, Engelsberg (DE)

Correspondence Address: Gary M. Nath, NATH & ASSOCIATES PLLC, 1030 15th Street, N.W. - 6th Floor, Washington, DC, 20005, US

(21) Appl. No.: 10/201,947

(22) Filed: Jul. 25, 2002

Related U.S. Application Data
(63) Continuation of application No. PCT/EP01/01634, filed on Feb. 14, 2001.

(30) Foreign Application Priority Data
Feb. 15, 2000 (DE) 100 06 539.2

(51) Int. Cl. C08G 18/00

(52) U.S. Cl. 528/44

(57) ABSTRACT

The use of aqueous isocyanate-free polyurethane dispersions with a solids content of ≧30 wt. % and a solvent content of ≦10 wt. % in formulations for crack sealing coating systems is disclosed. Said use may be in a) primer, floating screed, floor coatings, spray coatings and/or sealants, on, preferably, primed building surfaces, b) roof coatings or paints and c) sealing of open-cast or subterranean mines. According to the invention, the disclosed polyurethane dispersions are not just more environmentally-friendly and easier to use, but also give a partly improved product property to the corresponding crack sealing coating systems, such as, for example, mechanical properties (tensile strength, stretching under tension, tear elongation), UV resistance and colour stability.

### TECHNICAL FIELD

The present invention relates to the use of aqueous polyurethane dispersions in formulations for crack sealing coating systems.

### PRIOR ART

Despite comprehensive, frontier-crossing efforts to control immission of pollutants that have an adverse effect on the environment by means of legal regulations and limit values, damage to concrete building structures cannot be completely avoided and excluded. This is due to various reasons. On the one hand, air pollutants such as nitrogen oxides and sulfur dioxide due to exhaust gases caused by traffic, industry and heating are still one of the main reasons for the partly serious damage to parking garages, bridges and tunnels. On the other hand, destructions due to thawing salts at insufficiently protected concrete building structures were unfortunately simply provoked in the past due to lack of quality awareness and lack of care.

Surface protection systems have been successfully used for many years in order to increase the durability of concrete building structures. The following effects are achieved in the case of a void-free application:

Protection of the concrete against penetrating water and pollutants dissolved therein (thawing salts)

Prevention of the corrosion of the reinforcement

Prevention of frost-thaw damage

Prevention of osmosis

Protection of the concrete against gaseous pollutants (carbonation)

Avoiding of crack formation in the concrete (above all due to corrosion of the reinforcement)

Protection of the concrete against the action of chemicals

An overview of the most important types of surface protection systems for concrete protection and rehabilitation is given in M. Bock in: Polyurethane für Lacke und Beschichtungen, U. Zorll (publisher), Vincentz Verlag, Hanover 1999 and W. Michel, beton 5 (1998) 295-296.

Coatings of Top Floors of Parking Areas

In the past, top floors of parking areas were often only provided with a sealing as a protection. However, DIN 1045 should be decisive for this. There it is demanded in section 17.6.1.5 that building components made of reinforced concrete, where cracks across the entire cross-section must be expected, must always be provided with a special protection, if water with a high content of chloride (e.g. due to the use of thawing salt) acts on these parts. Horizontal plane load-bearing structures that are mounted in a statically indeterminate fashion are substantially meant by this, and this also includes top floors of parking areas. Due to the forced loads, cracks are practically unavoidable here.

A crack-sealing coating of the reinforced concrete is recommended as a special protective measure.

Above all, the prerequisites for a durable crack sealing of existing and newly formed separation cracks under temperature- and load-dependent movements, namely with a minimum crack sealing of 0.3 mm in the temperature range of −20 to +70° C. are concerned here. Coatings for top floors of parking areas, which correspond to the requirements of the guidelines are applied with a layer thickness of 3 to 4.5 mm.

Both one-layer and two-layer systems are allowable for this. In the case of two-layer systems the two layers have different functions: Crack sealing in particular at low temperatures must be ensured with the lower layer. The cover layer above all counteracts wear, it must withstand mechanical, chemical and atmospheric loads. One-layer systems must comply with all these requirements at the same time. In order to be able to ensure crack sealing at −20° C. and tensile strength, tear-propagation and abrasion resistance in the case of the respective material, a careful selection of binding agents and a fine tuning of the production process is required for its formulation.

Nowadays, both types of systems—one- and two-layer—are mainly formulated on the basis of polyurethane. However, mostly the one-layer variant is economically more advantageous.

Nowadays, the requirements for crack-sealing, practicable coatings for parking garages and subterranean garages are defined in two codebooks in Germany: Firstly, the OS-F systems in accordance with the “Additional Technical Contractual Regulations for the Protection and Maintenance of Concrete Building Components” (called for short ZTV-SIB) and, secondly, the OS-11 systems in accordance with the “Guideline for the Protection and Repair of Concrete Building Components” (called for short “Rili-SIB). The extent of validity of ZTV-SIB is basically restricted to building structures that are within the sphere of responsibility of the Federal Ministry of Traffic. However, in practice, approvals in accordance with this codebook, are also required of private or communal proprietors. The codebook Rili-SIB has a more general sphere of validity. It was prepared by the German Commission for Reinforced Concrete (DafStb) for concrete building structures of civil engineering. The technical requirements for crack-sealing, practicable coatings, whether OS-F or OS-11, are almost identical in both codebooks. Both ZTV-SIB and Rili-SIB prescribe standard structures. Part 2 of Rili-SIB originating from 1990 contains three standard structures for OS-11 coatings. The implementation variants that are customary nowadays are the structures A and B in accordance with ZTV-SIB. They are described in the “Technical Delivery and Technical Testing Conditions for Surface Protection Systems” (TL/TP-OS 1996) which were published at the beginning of 1997. Structure A is comparable to structure 1 of Rili-SIB. A so-called two-layer structure is concerned. The main functions—crack sealing and wear resistance—are fulfilled by two separate layers. Structure B is a so-called one-layer structure, where the two main functions must be fulfilled by one layer. It is the most modern coating structure and was only integrated in a codebook with the new edition of TL/TP-OS in 1996. There is no comparable standard structure for this in Rili-SIB. Cover sealings are only required for one-layer structures in accordance with ZTV-SIB. However, in practice, they are unrenounceable in all cases, since the scattered layers without cover sealing get extremely dirty, can almost not be cleaned and, moreover, exhibit signs of very high wear. If a system is processed with a cover sealing, it must be tested, as well, since it has a decisive influence on properties such as grip, wear and crack sealing.

In order to combine these two standards the draft of a new codebook was prepared. In it, a new surface protection system with static crack sealing capability for passable and practicable, mechanically loaded surfaces is described with OS 13. On the other hand, surface protection systems in accordance with OS 11 (OS-F) must have a dynamic (temperature- and load-dependent) crack sealing of class II_{T+L} (cf. Table 1).

TABLE 1
Surface Protection Systems in Accordance with OS 11 (OS-F) and OS 13

| Designation of system | OS 11 (OS-F) | | OS 13 | |
|---|---|---|---|---|
| Short description | Coating with increased crack sealing capability for | | Coating with static crack sealing capability | |
| | passable and practicable surfaces | | for passable and practicable, mechanically loaded surfaces | |
| Fields of application | Naturally weathered concrete building components | | Mechanically and chemically loaded, roofed in concrete | |
| | with cracks and/or separation cracks near the surface | | building components with cracks near the surface, also | |
| | and systematic mechanical load, also in the spraying | | in the spraying range of thawing salts, e.g. open parking | |
| | range of thawing salts, e.g. open top floors of parking | | garages and subterranean garages | |
| | garages and bridge crowns | | | |
| Properties | a) | Prevention of water absorption | a) | Prevention of water absorption |
| | | Prevention of the penetration of concrete- | | Prevention of the penetration of concrete- |
| | | and steel-attacking substances | | and steel-attacking substances |
| | | Durable crack sealing of existing and | | Durable crack sealing of existing and |
| | | newly developed separation cracks under | | newly developed separation cracks near the surface |
| | | temperature- and load-dependent | | Improvement of resistance against and frost/thawing |
| | | movements | | salt |
| | | Improvement of resistance against frost | | Improvement of chemical resistance |
| | | and frost/thawing salt | | Improvement of grip |
| | | Improvement of grip | | Impact resistance |
| | | | | In addition, depending upon the requirements: |
| | b) | Prevention of carbon dioxide diffusion | | Suitability in the case of rear-side moistening |
| | | High reduction of steam diffusion | b) | Prevention of carbon dioxide diffusion |
| | | | | High reduction of steam diffusion |

| Binding agent groups | Polyurethane | | Polyurethane |
|---|---|---|---|
| of the mainly effective | Modified epoxide resins | | Modified epoxide resins |
| surface protection layer (hwO) | 2-K polymethyl methacrylate | | 2-K polymethyl methacrylate |
| Standard structure | a) | 1. Priming | 1. Priming |
| | | 2. Elastic surface protection layer (hwO) | 2. Wear-resistant, possibly prefilled surface protection |
| | | 3. Wear-resistant, prefilled cover layer; | layer; scattered (hwO) |
| | | scattered (hwO) | 3. Cover sealing |
| | | 4. Possibly cover sealing | |
| | b) | 1. Priming | |
| | | 2. Wear-resistant, prefilled surface protection layer; | |
| | | scattered (hwO) | |
| | | 3. Possibly cover sealing | |

Balcony Sealings

Balconies, terraces, loggias, etc. are located in the outer area of buildings and, consequently, are subjected to great weather factors and mechanical wear. Therefore, the supporting concrete foundation needs a high-grade protection, in particular against penetrating moisture. If this is not given, moisture can also penetrate into adjacent floors, the reinforcement of the concrete slab and concreted in balcony balustrade mountings may corrode or chipping off of the concrete layers occurs due to frost-thaw cycles. The result is a reduced load-bearing capacity of the balcony slab, and, finally, the balcony can no longer be used.

Here, the PUR liquid plastic can fulfill the necessary protective function and, at the same time, it serves for the decorative design of the balcony surface.

Standards and Code Books

There are no special code books for the sealing of balconies and loggias with liquid plastics.

The general standards must be observed:

Guideline for the Protection and Repair of Concrete Building Components, published by Deutscher Ausschuβ für Stahlbeton, Berlin,

Additional Technical Contractual Conditions and Guidelines for the Protection and Repair of Concrete Building Components 1990 (UTV-SIB), published by the Federal Ministry of Traffic.

Liquid plastics for balcony sealing must have a resistance to light and weathering resistance and remain elastic in the case of changes in temperature. These requirements can be fulfilled with PUR materials.

Coatings on the basis of IPDI polycarbonate prepolymers and HDI polyisocyanates are sufficiently fast to light and, moreover, can be used as a transparent sealing. Coatings on the basis of TDI prepolymers are used as highly flexible, two-component membranes, namely either in combination with cover layers on the basis of IPDI or HDI prepolymers or as a sealing under ceramic tiles.

The following applies to reactants: The use of polycarbonate polyols in the PUR prepolymers results in weather-resistant, elastic coatings. Prepolymers based on polyether/polyester polyols are not weather-resistant and, therefore, cannot be used in the final layer exposed to atmospheric influences. In addition to the binding agent, the formulations mostly contain mineral fillers, pigments and many other additives.

Both solvent-containing one-component PUR coatings that cure with air humidity and solvent-free two-component systems proved their worth for balcony sealings. The most important PUR raw materials for balcony sealing are summarized in Table 2.

TABLE 2
PUR Raw Materials for Balcony Sealing

| Binding agent base | Raw material combinations |
|---|---|
| one-component aliphatic | IPDI polycarbonate prepolymers |
| | IPDI polyisocyanates, bisoxazolidines |
| two-component aliphatic | HDI polyisocyanates, IPDI/HDI |
| | polyisocyanates, |
| | polycarbonate/polyether/polyester polyols |
| two-component aromatic | TDI polyether prepolymers, amines |

Structure of Balcony Coatings

Passable PUR Balcony Coatings

Depending upon the crack formation to be expected in the concrete slab, a distinction can be made between two structures:

For concrete slabs with smaller cracks (up to approx. 0.5 mm):

a) Priming

b) Elastic PUR coating on the basis of aliphatic polyisocyanates.

For concrete slabs with wider cracks (1 to 2 mm):

a) priming,

b) intermediate layer, highly flexible PUR coating on the basis of aromatic polyisocyanates,

c) cover layer, elastic PUR coating on the basis of aliphatic polyisocyanates.

Moreover, there is the possibility of installing an elastic sealing in the form of a membrane on a concrete slab under tiles. This results in the following structure scheme:

a) priming,

b) highly flexible PUR coating on the basis of aromatic polyisocyanates,

c) highly flexible PUR coating on the basis of aromatic polyisocyanates with the interspersing of sand;

d) plastic-modified mortar (PCC mortar),

e) tiles.

Processing Techniques

Prior to rehabilitation, it must be checked whether the balcony floor slab has still a load-bearing capacity. Old coatings must either be removed or well roughened prior to the application of PUR sealing.

The concrete surface should be shot-peened in advance, very smooth surfaces must be roughened in another way. Fat- or oil-containing impurities must be removed. It is of importance that the residual moisture of the foundation does not exceed four percent.

The priming serves for foundation solidification and for binding dust. Thus, a good adhesion of the following layers on the foundation is ensured. Mostly, solvent free epoxide resin systems are used for priming, in which sand is interspersed for improving adhesion. One- or two-component polyurethanes or dispersion-based products are also used for primings.

Both solvent-containing one-component and low-solvent two-component PUR formulations come into consideration as coating materials. As described above the coating structure depends on the problem definition.

Plastic chips can be interspersed in the still not cured coating for the decorative design of the sealing, but also to ensure its antiskid property. Subsequently, this surface is sealed with a transparent cover layer of PUR liquid plastic that is fast to light. A further design possibility is opened up with the incorporation of Colorit quartz into the transparent PUR coating.

In general, PUR liquid plastics can be applied by means of rolling, spreading or by means of a toothed doctor blade.

Flat Roof Sealings

The sealing of flat roofs with liquid film does not play any dominant role in practice. So far, the predominant majority of flat roofs have still been sealed with web material such as with (polymer-modified) bitumen, rubber polymers or PVC.

Nevertheless, the sealing with a liquid film seems to be a safe and economically interesting for roofs with many openings (ventilators, roof cupolas, waste-pipe, etc.). Apart from polyurethanes, unsaturated polyesters and acrylates are typical binding agents for liquid films.

PUR liquid plastics for roof sealings are coating materials which are applied in a liquid state and cure to a permanent-elastic, weather resistant membrane. They are mainly used in the rehabilitation of pervious flat roofs, but also for new buildings. On the one hand, a long service life, and, on the other, a low diffusion resistance against steam are important properties of such a coating, so that thoroughly moistened roofs can still dry up after the application of the coating.

As opposed to the use of sealing webs, the use of PUR liquid plastics results in a seamless sealing.

Standards and Code Books

The following code books are relevant for flat roof rehabilitation with liquid plastics:

Guidelines for the Planning and Implementation of Roofs with Sealings (Flat Roof Guidelines), published by Zentralverband des Deutschen Dachdeckerhandwerks,

DIN 4102/Part 7 “Resistance Against Radiating Heat and Flying Sparks”,

UEATC Agreement (EOTA=European Organization for Technical Approvals, in future).

In the case of one-component formulations a bubble-free curing of the coating in the required layer thickness of approx. 2 mm is ensured by bisoxazolidine that reacts with air humidity and, when doing so, releases amino and hydroxyl groups which, in turn, complete the reaction with the polyurethane prepolymers. Due to this, a direct reaction between polyurethane prepolymers and air humidity is suppressed, which would result in the formation of carbon dioxide and thus of bubbles. Roof sealings on the basis of aromatic polyisocyanates must be stabilized by means of soot or aluminum paste (aluminum powder in softener). The latter causes a reflection of solar radiation and, thus, contributes to weather stabilization of the polyurethane coating.

Two-component, highly reactive formulations are also usable for these purposes. They dry fast and, consequently, can only be applied with special machines. These products may e.g. consist of the mixture of a TDI prepolymer and a MDI polyisocyanate which is cured with a combination of polyol and amine.

Here, light stabilization is achieved by means of the addition of soot or aluminum powder or by means of an additional sealing with a polyurethane on the basis of aliphatic polyisocyanate. Table 3 provides an overview of types and properties of PUR liquid films.

TABLE 3
Types and Properties of PUR liquid films for flat roof sealing

| Binding | | | Additional |
|---|---|---|---|
| agent basis | Type of processing | Raw materials | indications |
| one-component | manual processing | TDI polyether | Systems |
| aromatic | | prepolymers and | must be |
| | | oxazolidines | provided |
| | | | with alum- |
| | | | inum pig- |
| | | | ments or |
| | | | with soot |
| | | | to be |
| | | | weather- |
| | | | resistant |
| one-component | manual processing | IPDI polycarbonate | Systems can |
| aliphatic | | prepolymers and | be adjusted |
| | | oxazolidines | in all color |
| | | | shades |
| two-component | spray processing | TDI and MDI | Systems |
| aromatic | by means of two- | prepolymers, | must be |
| | component system | polyether, amines | provided |
| | | | with alum- |
| | | | inum pig- |
| | | | ments or |
| | | | with soot or |
| | | | with an addi- |
| | | | tional sealing |
| | | | to be |
| | | | weather- |
| | | | resistant |

One- or two component, manually processable roof coatings that are optionally adjustable in their color can be formulated on the basis of prepolymers of aliphatic polyisocyanates and polycarbonate polyols.

Structure of the Roof Sealing

When being rehabilitated with PUR liquid films, sealing materials that have come pervious, mostly bitumen webs, must not be removed in advance. Depending upon the type of application of the PUR liquid film, there are two alternatives:

Manually processable IK systems consisting of:

a) primer (first coat for solidifying the foundation and for dust bonding),

b) base coat (approx. 1.5 kg·m⁻² PUR liquid plastic, applied by means of rolls),

c) non-woven polyester (approx. 100 g·m⁻² is incorporated into the liquid PUR coating material, makes mechanical stabilization and observing of the layer thickness aimed at) possible;

d) Cover layer (approx. 1 kg·m⁻² PUR liquid plastic is applied after drying of the base coat and covers the non-woven polyester).

Machine-processable two-component spray systems consisting of:

a) primer,

b) two-component PUR spray coating (minimum layer thickness 2 mm).

Prior to the application of the PUR liquid plastic, the following conditions must be complied with:

the foundation must be clean and load-bearing,

the residual moisture of the foundation and of the insulating layers located under it must be four percent as a maximum.

The processing of two-component, highly reactive sealing systems is carried out in two-component systems provided with gear pump or reciprocating pumps.

Table 4 summarizes the primers customary for PUR liquid plastics. Primers and one-component PUR liquid plastics are applied by means of spreading, rolling or spraying by means of one-component airless systems.

TABLE 4
Customary Primers for PUR Liquid Plastics on Various Foundations

| Foundation | Primer |
|---|---|
| Concrete | MDI polyether prepolymers or |
| | sand-blasted epoxide resin primers |
| Asbestos | MDI polyether prepolymers or sand- |
| | blasted epoxide resin primers |
| Roofings | MDI |

Floor Coatings

Floors are of special importance for the functionality of industrial enterprises. The flawless course of manufacture and the proper storage of the products depend on their quality.

Accordingly, the requirements for industrial floors are high and manifold. Depending upon the type of use and the load, different properties are required such as:

mechanical and dynamic loading capacity^{a} (resistance to pressure, impact strength, shock resistance, abrasion resistance, freedom from cracks),

chemical resistance^{a},

electrical resistance^{b},

temperature resistance^{a} (permanent and short-term resistance),

color shade and weather resistance^{a},

insulation^{a} (acoustic, thermal),

evenness (DIN 18 202, Part 5^{c}),

slip resistance^{c},

little preservation expenditure, capable of being cleaned^{a,c},

easy to repair^{a},

Service life, cost-benefit factor. a) depends mainly on the selection of the raw materials; b) depends mainly on the formulation; c) depends mainly on the application.

Many of the desired properties are e.g. defined according to DIN 28 052 and, in their entirety, result in the use profile.

The primary object of floors is to absorb and to distribute static and dynamic loads. Irrespective of its actual structure, a floor can be defined as consisting of two layers, namely

1. a supporting layer which consists or may consist e.g. of a monolithic concrete slab or of a concrete slab and flooring screed, and

2. the wearing surface firmly connected to the supporting layer. It must withstand chemical loads and fulfill further user-specific requirements, e.g. slip resistance cleanability or optical appearance, as it is already indicated in greater detail above.

Floor coatings are such wearing surfaces.

In order to obtain a fully functioning compound system, the properties of the individual layers must be harmonized. Wearing surfaces are often produced on the basis of artificial resins, in particular reactive systems such as polymethyl methacrylate (PMMA), epoxide resin (EP) or polyurethane (PUR). The floor coating can be implemented as sealing, as thin coating up to 0.3 mm or as coating with a layer thickness of up to 3 mm. Further application possibilities comprise artificial resin screed or decorative artificial screed with layer thicknesses of more than 3 to approx. 10 mm (ornamental gravel coating). In the latter case, the wearing surface, in addition, also has a load capacity. Sealings, thin coatings and coatings are formulated in a solvent-free to low-solvent fashion, and artificial resin screeds are basically formulated in a solvent-free fashion.

PUR coatings may be adjusted from highly elastic (for membranes, sports facilities) to hard and highly chemical-resistant (for chemical plants).

Typical uses of such coatings are:

one-component and two-component primings and sealings,

sports hall coverings,

membrane coatings

industrial floor coatings from viscoplastic to hard in accordance with the OS or WHG Regulations,

one-component and two-component artificial resin mortar and ornamental gravel coatings.

The following properties typical of PUR are decisive for the success of the use:

through-curing even in the case of low temperatures,

good adhesion

predeterminable hardness and resulting from it:

very good chemical resistance in the case of hard coatings,

crack sealing with elastic and visoplastic adjustments,

jointless laying,

steam diffusion resistance that can be influenced (for application on anhydrite and magnesite screeds),

good hydrolysis resistance and little water absorption,

very good weather and color shade stability in the case of coatings on the basis of select aliphatic products.

The broad use for more than three decades with a plurality of reference objects proves the excellent quality and long service life of PUR floor coatings.

The most important basic products for the production of PUR floor coatings are mixtures of isomers and prepolymers of diphenyl methane diisocyanate (MDI). Moreover, oligomers and/or adducts of hexamethylene diisocyanate (HDI) and isophorone diisocyanate (IPDI) and prepolymers of toluylene diisocyanate (TDI) and of isophorone diisocyanate (IPDI) are used.

Polyhydroxy compounds are primarily available as reactants, but also aromatic and sterically hindered, aliphatic amines and latent hardening agents. The latter are converted into reactive products due to the influence of moisture. Moreover, the reaction of the polyurethane prepolymers with moisture for polymer formation is used in the classic one-component systems (one-component PUR). However, only thin-layer films can be produced with this reaction, since, otherwise foam formation occurs.

The use of this chemistry is also successful from the aqueous phase if special polyol dispersions are used. Here, it is possible to cover a broad layer thickness range. However, the additional co-use of cement and/or hydrated lime is necessary for thick layer thicknesses (so-called 3K systems) in order to intercept the carbon dioxide formed under the action of water. Such coatings excel by an extremely high chemical resistance (UCrete®, Desmolith®).

Low-molecular and higher molecular products—straight-chain or branched—with different chemical structure are available as polyhydroxy compounds. Polyester polyols ensure, for instance, a good solvent resistance, polyether polyols ensure a considerable acid and alkali resistance, acrylic and methacrylic acid derivatives ensure a high weather resistance.

Disturbing influences must be avoided when processing these materials at the building site. The risk of foam formation in the application of thick layer thicknesses, induced by the ubiquitous humidity at building sites must be especially mentioned here. In this respect, systems with a short processing time, which are customarily applied by means of spraying, or such that contain amines instead of the polyhydroxy compounds are hardly problematic. It is different with systems with long processing times; here, their hydrophilicity and/or hydrophobic nature and the concomitant water absorption from the environment play an essential part. In this connection, polyether polyols modified to be hydrophobic by means of fatty acid have proved their worth. The co-use of molecular sieves that bind the water introduced by fillers, pigments and the like is necessary. Floor coating substances that are building site oriented are obtained with these product variations.

The production of the coating materials takes e.g. place in the dissolver or butterfly mixer, if possible, under vacuum. With this, fillers, pigments, molecular sieve and surface-active additives are incorporated into the polyol component. The production under vacuum facilitates the removal of air so that the wetting of the additives by the binding agent is improved. Prior to the filling of the coating material into industrial cases a suitable deaeration agent, e.g. on the basis of silicone, is additionally added. This subsequent addition ensures a pore-free, smooth surface of the coating.

Prior to the application of the polyurethane coating it must be ensured that prerequisites which, in general, apply to floor coatings, are complied with. These are laid down in the “Guideline for the Protection and Repair of Concrete Building Components” of the German Committee for Reinforced Concrete. The absence of loose parts, grout and impurities is required, but also that the application must only be carried out on load-carrying, dry to slightly moist foundations (customarily ≦4% water), whose surface tear-off strength must be at least 1.5 MPa. During processing, the ambient temperature should range from 8 to 40° C. and the temperature of the object should be at least three degrees above the dew point.

The mixing of the polyol and polyisocyanate components onsite takes place by means of a cage or blade mixer. The layer structure customarily consists of a priming, a possibly necessary scratch-knife application to eliminate roughnesses and the actual floor coating. The application is carried out by means of a roll or toothed knife applicator. The structure can finally be completed with a decorative, abrasion-resistant covering varnish.

The fact is disadvantageous in all these formulation components on the basis of polyurethane that these products contain isocyanate and, partly, contain large amounts of solvent so that these components involve a significant risk potential for man and the environment, for which reason special environmental-control and safety measures are required for their processing. Moreover, these isocyanate-containing formulations cure extremely slowly at low temperatures and, often, only reach a reduced property level due to side reactions with air humidity.

Representation of the Invention

Consequently, the present invention was based on the object of developing formulations for crack-sealing coating systems on the basis of polyurethane dispersions, which do not have the aforementioned disadvantages of the prior art, but excel both by a good environmental acceptability and an improved processability.

According to the invention, this object was attained by using aqueous, isocyanate-free polyurethane dispersions with a solids content of ≧30% by weight and a solvent content of ≦10% by weight in formulations for crack-sealing coating systems, which are selected from:

a) primer, floating screed, cover layers, spray coatings and/or sealings on preferably primed building surfaces,

b) (possibly flame-proofed) roof coatings or paints, and

c) (possibly flame-proofed) sealings of building structures in overground and underground construction.

Surprisingly, it became apparent that these polyurethane dispersions are not only environmentally more acceptable and more easily processable, but, moreover, make partly improved product properties of the corresponding crack-sealing coating systems possible such as mechanical properties (tensile strength, elongation at tensile strength, elongation at tear), UV resistance and color stability.

The aqueous, isocyanate-free polyurethane solutions suggested according to the invention have a solids content of ≧30% by weight, preferably 40 to 60% by weight, and a solvent content of ≦10% by weight, preferably ≦5% by weight. An isocyanate content of the polyurethane dispersion of <0.1% by weight, preferably <0.01% by weight is understood by “isocyanate-free” within the purview of the present invention. Especially preferred, the polyurethane dispersion according to the invention does not contain any isocyanate. Preferably, polyurethane dispersions on the basis of polypropylene glycols, polycarbonate polyols or mixtures thereof with a mean molecular weight of 500 to 5000 daltons are used. According to an especially preferred embodiment, solvent-free polyurethane dispersions on the basis of polypropylene glycols with a solids content of 50 to 60% by weight and low-solvent polyurethane dispersions on the basis of polycarbonate polyols with a solids content of 45 to 55% by weight and a solvent content of ≦5% by weight are used.

The polyurethane dispersions are preferably based on polyurethane prepolymers which were prepared with an NCO/OH equivalent ratio of from 1.2 to 2.2, in particular from 1.4 to 2.0.

The polyurethane dispersions are preferably based on polyurethane prepolymers that have a content of carboxylate groups of from 10 to 40 meq (100 g)⁻¹, in particular from 15 to 35 meq (100 g)⁻¹ and an acid number of from 5 to 25 meq KOH g⁻¹, in particular from 7.5 to 22.5 meq KOH g⁻¹.

The polyurethane dispersions have a preferred average particle size of from 50 to 500 nm, the corresponding indications relating to measurements by means of photon correlation spectroscopy (PCS).

The polyurethane polymers have a preferred average molecular weight of from 50,000 to 500,000 daltons, the corresponding indications relating to the number average Mₙ and measurements by means of gel permeation chromatography (GPC).

Such aqueous polyurethane dispersions are already known, the preferred polyurethane dispersions and its production being described in the German patent applications DE 198 12 751 and DE 199 59 170.

The production process according to DE 199 59 170 is characterized in that

a) at first, a premix of a polyol component (A) is produced that consists of from 5 to 25 parts by weight of a diol (A) (i) with a molar weight of from 500 to 5,000 daltons, from 0.5 to 5 parts by weight of a polyhydroxy alkane (A) (ii) and from 0 to 5 parts by weight of an anionically modifiable dihydroxy alkane carboxylic acid (A) (iii) and from 0 to 9 parts by weight of a solvent component (B),

b) from 5 to 50 parts by weight of a polyisocyanate component (C) is reacted with from 11 to 39 parts by weight of the premix from stage a) to a polyurethane preadduct, the NCO/OH equivalent ratio in this stage being from 1.75 to 8.0,

c) the polyurethane preadduct from phase b) is either reacted with from 5 to 33 parts by weight of the premix from stage a) or 0.5 to 5 parts by weight of an anionically modifiable dihydroxy alkane carboxylic acid (A) (iii) to a polyurethane prepolymer, the NCO/OH equivalent ratio in this stage being from 1.5 to 5.0,

d) the polyurethane prepolymer from stage c) is then mixed with a prefabricated mixture of from 5 to 225 parts by weight of water, from 0.5 to 4 parts by weight of a neutralization component (D) and from 0 to 1 parts by weight of a defoamer component (E) and, finally or at the same time,

e) the aqueous polyurethane prepolymer from stage d) is reacted with 0.025 to 4 parts by weight of a chain extender component (F) which is diluted at the ratio of from 1:10 to 10:1 with previously withdrawn moeties of the water.

In reaction stage a) a premix of a polyol component (A) is prepared, that consists of from 5 to 25 parts by weight of a diol (A) (i) with a molar weight of from 500 to 5,000 daltons, from 0.5 to 5 parts by weight of a polyhydroxy alkane (A) (ii) and from 0 to 5 parts by weight of an anionically modifiable dihydroxy alkane carboxylic acid (A) (iii) and from 0 to 9 parts by weight of a solvent component (B). The implementation of the reaction stage a) is relatively unproblematic in view of the reaction conditions. The components (A) (i), (A) (ii) and, possibly (A) (iii) and B are added in an optional order and mixed till there is a homogeneous solution. The reaction stage a) is implemented at a preferred temperature of 20 to 120° C., in particular at 60 to 80° C.

The component (A) (i) with a moiety of from 5 to 25 parts by weight consists at least of one higher molecular diol with two hydroxyl groups that are reactive to polyisocyanates and an average molecular weight (number average Mₙ) of from 500 to 5,000 daltons, in particular from 1,000 to 4,000 daltons, namely in particular on the basis of a polyether, polyester, α,ω-polymethacrylate diol or mixtures thereof. Polymer diols such as polyalkylene glycols, aliphatic or aromatic polyesters, polycaprolactones, polycarbonates, macromonomers, telechelics or epoxide resins or mixtures thereof are particularly concerned. Polyalkylene glycols are obtained from monomers such as ethylene oxide, propylene oxide, butylene oxide, styrene oxide, tetrahydrofuran by means of polymerization in the presence of boron trifluoride or by means of polyaddition of starter compounds with reactive hydrogen atoms such as water, alcohols, amines or bisphenol A. Mixtures of the monomers can also be used at the same time or one after another. For instance, polyethylene glycols, polypropylene glycols (e.g. Voranol® types of the Dow company, Acclaim® types of the Lyondell company), mixed polyglycols on the basis of ethylene oxide and propylene oxide and polytetramethylene glycols and/or polytetrahydrofurans (e.g. PolyTHF 2000 of the BASF company) can be used as suitable polyalkylene glycols. Linear and/or difunctional polypropylene glycols with an average molecular weight (number average Mₙ) of 1,000 to 4,000 daltons are preferably used.

Aliphatic or aromatic polyester diols are obtained by means of the polycondensation reaction and/or polyaddition reaction from dihydric or polyhydric alcohols and bivalent or polyvalent carboxylic acids, carboxylic acid anhydrides or carboxylic acid esters. For instance, condensates on the basis of 1,2-ethane diol and/or ethylene glycol, 1,4-butane diol and/or 1,4-butylene glycol, 1,6-hexane diol and/or 1,6-hexamethylene glycol and 2,2-dimethyl-1,3-propane diol and/or neopentyl glycol and 1,6-hexane dioic acid and/or adipic acid and 1,3-benzene dicarboxylic acid and/or isophthalic acid (e.g. Bester types of the Poliolchimica company) can be used as suitable aliphatic or aromatic polyesters. Polycaprolactones (e.g. Capa types of the Solvay Interox company) and polycarbonates (e.g. Desmophen C 200 of the Bayer company) are likewise included in this group of the polyesters. The first ones are obtained by reaction phosgene and/or aliphatic or aromatic carbonates such as diphenyl carbonate or diethyl carbonate with dihydric or polyhydric alcohols. The latter ones are prepared by means of the polyaddition of lactones, such as ε-caprolactone, to starter compounds with reactive hydrogen atoms such as water, alcohols, amines or bisphenol A. Synthetic combinations of polyesters, polycaprolactones and polycarbonates are also conceivable. Linear and/or difunctional aliphatic or aromatic polyester polyols with an average molecular weight (number average Mₙ) of from 1,000 to 4,000 daltons. Macromonomers, telechelics or epoxide resins are also suitable. Polyhydroxy olefins such as α,ω-dihydroxy polybutadienes, α,β-dihydroxypoly(meth)acrylates, α,ω-dihydroxypoly(meth)acrylates or α,ω-dihydroxy polysiloxanes can be used as suitable macromonomers and telechelics. α,ω-dihydroxy polyolefins such as α,ω-poly(methyl methacrylate) diol (trade name: TEGO® Diol MD-1000) of the molecular weight 1,000 daltons, α,ω-poly(n-butyl methacrylate) diols of the molecular weight 1,000 and 2,000 daltons (trade name: TEGO® Diol BD-1000, TEGO® Diol BD-2000) or α,ω-poly(2-ethylhexyl methacrylate) diol (trade name: TEGO® Diol OD-2000) of the Tego Chemie Service GmbH company are preferred. The epoxide resins are preferably hydroxy-functional derivatives of bisphenol-A diglycide ether (BADGE). That is to say that linear and/or difunctional aliphatic or aromatic polyalkylene glycols, polyester polyols and α,ω-dihydroxy polyolefins with an average molecular weight (number average Mₙ) of 1,000 to 4,000 daltons are preferably used.

The component (A) (ii) with a moiety of from 0.5 to 5 parts by weight consists at least of one low molecular polyhydroxy alkane with two or more hydroxyl groups that are reactive to polyisocyanates and a molecular weight of from 50 to 500 daltons. 1,2-ethane diol and/or ethylene glycol, 1,2-propane diol and/or 1,2-propylene glycol, 1,3-propane diol and/or 1,3-propylene glycol, 1,4-butane diol and/or 1,4-butylene glycol, 1,6-hexane diol and/or 1,6-hexamethylene glycol, 2-methyl-1,3-propane diol (trade name MPDiol Glycol® of the Arco Chemical company), 2,2-dimethyl-1,3-propane diol and/or neopentyl glycol, 1,4-bis-(hydroxy methyl) cyclohexane and/or cyclohexane dimethanol, 1,2,3-propane triol and/or glycerol, 2-hydroxymethyl-2-methyl-1,3-propane diol and/or trimethylol ethane, 2-ethyl-2-hydroxymethyl- 1,3-propane diol and/or trimethylol propane, 2,2-bis-(hydroxymethyl)-1,3-propane diol and/or pentaerythritol can e.g. be used as suitable low molecular polyhydroxy alkanes.

The component (A) (iii) with a moiety of from 0 to 5 parts by weight consists of at least one low molecular and anionically modifiable dihydroxy alkane carboxylic acid with two hydroxyl groups that are reactive to polyisocyanates and one or more carboxyl groups that are inert to polyisocyanates, which can be wholly or partly converted into carboxylate groups in the presence of bases. 2-hydroxymethyl-3-hydroxy propionic acid and/or dimethylol acetic acid, 2-hydroxymethyl-2-methyl-3-hydroxy propionic acid and/or dimethylol propionic acid, 2-hydroxy-methyl-2-ethyl-3-hydroxy propionic acid, and/or dimethylol butyric acid, 2-hydroxymethyl-2-propyl-3-hydroxy propionic acid and/or dimethylol valeric acid can e.g. be used as low molecular and anionically modifiable dihydroxy alkane carboxylic acids. Bishydroxy alkane carboxylic acids with a molecular weight of 100 to 200 daltons are preferably used and preferably dimethylol propionic acid (trade name DMPA® of the Mallinckrodt company) is used.

The solvent component (B) with a moiety of 0 to 9 parts by weight consists of at least one dissolver that is inert to polyisocyanates and wholly or partly miscible with water, which remains in the polyurethane dispersion after preparation or is wholly or partly removed by means of distillation. Dissolvers which remain in the dispersion after the preparation act as auxiliary coalescing agents. Suitable dissolvers are e.g. high-boiling solvents such as N-methyl pyrrolidone, dipropylene glycol dimethyl ether (Proglyde DMM® of the Dow company), low boiling solvents such as acetone, butanone or optional mixtures thereof. High-boiling and hydrophilic organic solvents with a boiling point of more than 180° C. (normal pressure), and preferably N-methyl pyrrolidone, are preferably used.

11 to 39 parts by weight of the premix of stage a) are reacted with 5 to 50 parts by weight of a polyisocyanate component (C) to a polyurethane preadduct in the reaction stage b), the NCO/OH equivalent ratio in this stage being from 1.75 to 8.0. The NCO/OH equivalent ratio of the components (C) and (A) is preferably adjusted to a value of from 2.5 to 4.0 in the reaction stage b). The implementation of the reaction stage b) is relatively uncritical with regard to the reaction conditions. The formation of the polyurethane preadduct takes place in the fashion that the component (C) is mixed with part of the premix from the reaction stage a) that consists of the components (A) (i), (A) (ii) and, possibly, (A) (iii) and (B) within a period of time of a few minutes. The reaction stage b) is implemented at a preferred temperature of 60 to 120° C., in particular at 80 to 100° C. Due to the high excess of the polyisocyanate component (C) with respect to the polyol component (A), it can be worked with little and/or without solvent in the reaction stage b) depending upon the viscosity. Strictly NCO-terminated, short-chain polyurethane preadducts result.

The polyisocyanate component (C) consists of at least one polyisocyanate, polyisocyanate derivative or polyisocyanate homologs with two or more aliphatic or aromatic isocyanate groups. The polyisocyanates or combinations thereof that are sufficiently known in polyurethane chemistry are in particular suitable. 1,6-diisocyanatohexane (HDI), 1-isocyanato-5-isocyanatomethyl-3,3,5-trimethyl cyclohexane and/or isophorone diisocyanate (IPDI), bis-(4-isocyanatocyclohexyl) methane (H₁₂MDI), 1,3-bis-(1-isocyanato-1-methylethyl) benzene (mTMXDI) and/or technical isomer mixtures of the individual aromatic polyisocyanates can e.g. be used as suitable aliphatic diisocyanates. 2,4-diisocyanate toluene and/or toluene diisocyanate (TDI), bis-(4-isocyanatophenyl) methane (MDI) and possibly its higher homologs (polymeric MDI) and/or technical isomer mixtures of the individual aromatic polyisocyanates can e.g. be used as suitable aromatic diisocyanates. Moreover, the so-called “paint polyisocyanates” on the basis of bis-(4-isocyanatocyclohexyl) methane (H₁₂MDI), 1,6-diisocyanatohexane (HDI), 1-isocyanato-5-isocyanatomethyl-3,3,5-trimethyl cyclohexane (IPDI) are also basically suitable. The term “paint polyisocyanates” characterizes derivatives of these diisocyanates that comprise allophanate, biuret, carbodiimide, isocyanurate, uretdione, urethane groups, in which the residual content of monomeric diisocyanates was reduced to a minimum in accordance with the prior art. In addition to this, modified polyisocyanates can also still be used, which are e.g. accessible due to the hydrophilic modification of “paint polyisocyanates” on the basis of 1,6-diisocyanatohexane (HDI). The aliphatic polyisocyanates must be preferred over the aromatic polyisocyanates. Preferably, isophorone diisocyanate is used as the aliphatic polyisocyanate.

The polyurethane preadduct from stage b) is then either reacted with from 5 to 33 parts by weight of the premix from stage a) or 0.5 to 5 parts by weight of the anionically modifiable dihydroxy alkane carboxylic acid (A) (iii) to a polyurethane prepolymer in the reaction stage c), the NCO/OH equivalent ratio in these stage being 1.5 to 8.0. The NCO/OH equivalent ratio of the polyurethane preadduct from stage b) and the component (A) is preferably adjusted to a value of from 1.6 to 3.0 in the reaction stage c). The formation of the polyurethane prepolymer takes place in that fashion that the polyurethane preadduct from stage b) is mixed with the rest of the premix from stage a) that consists of the components (A) (i), (A) (ii), (A) (iii) and possibly (B) within a period of time of a few minutes. The polyurethane preadduct from reaction stage b) that is used in the reaction stage c) may, in addition to isocyanate groups, possibly also still contain free hydroxyl groups in the case of a corresponding process control and/or an incomplete reaction. The reaction stage c) is implemented at a preferred temperature of from 60 to 120° C., in particular at 80 to 100° C.

The preferred NCO/OH equivalent ratio of the total amount of the components (A) (polyols) and (C) (polyisocyanates) is adjusted to a preferred value of from 1.2 to 2.2, in particular from 1.4 to 2.0.

The reaction of the components (A) and (C) in the reaction stages b) and c) can be carried out in the presence of a catalyst system customary for polyaddition reactions at polyisocyanates. If required, these catalysts are added in amounts of from 0.02 to 1 parts by weight, based on the reaction batch. Customary catalysts for polyaddition reactions at polyisocyanates are e.g. dibutyl tin oxide, dibutyl tin dilaurate (DBTL), triethyl amine, tin(II) octoate, 1,4-diaza-bicyclo[2,2,2] octane (DABCO), 1,4-diazabicyclo[3,2,0]-5 nonene (DBN), 1,5-diaza-bicyclo[5,4,0]-7-undecene (DBU).

In the reaction stages b) and c), the reaction batch is preferably stirred under an inert gas atmosphere using the exothermics of the polyaddition reaction until the calculated and/or theoretical NCO content is achieved. The required reaction times are in the range of a few hours and are decisively influenced by reaction parameters such as the reactivity of the components, the stoichiometry of the components and temperature.

According to a preferred embodiment, the production of the polyurethane prepolymer is carried out in such a way that, in stage a) a premix of the components (A) (i), (A) (ii), (A) (iii) and, possibly, (B) is prepared, and the premix from stage a) is then used in stages b) and c).

Alternatively, a premix of the components (A) (i), (A) (ii) and possibly (B) is prepared in stage a), the premix from stage a) is then completely used in stage b) and the component (A) (iii) is then only reacted in stage c).

Due to the alternating NCO/OH equivalent ratios during the polyaddition reaction, this multi-stage addition of the polyol component results in different reaction kinetics and, thus, to a structure of the polyurethane polymer other than that in the conventional prepolymer mixing process according to the one-pot processes. In the case of a suitable process control and the use of diisocyanates with isocyanate groups of different reactivity, largely symmetrical polyurethane preadducts and polyurethane prepolymers are obtained, in which the hydroxyl groups of the individual polyols are reacted with isocyanate groups of the same reactivity. In this connection, in particular the apportioning of the premix produced in the reaction stage a) to the reaction stages b) and c) must be understood by a suitable process control. Moreover, diisocyanates with isocyanate groups of different reactivity provide narrower molecular weight distributions with less non-uniformity. Accordingly, polyurethane preadducts and polyurethane prepolymers with linear structure are preferred, which are composed of diol and diisocyanate components. The formation of these symmetrical segment structures is favored by the mild temperature control during the polyaddition reaction. Only weak exothermics of the polyaddition reaction can be observed in each case in the reaction stages b) and c), the endogenous reaction temperatures does not exceed beyond 90° C. Due to this, undesired side reactions of the NCO groups, e.g. with the carboxylate groups, can also be suppressed in a simple fashion without a special temperature control.

The viscosity of the polyurethane prepolymers is relatively low and largely independent of the structure of the used polyol and polyisocyanate components. Consequently, an addition of solvents to reduce viscosity or to improve the dispersing properties of the polyurethane prepolymers is only required in small amounts. The special structure of the polyurethane prepolymers makes the subsequent production of products with extremely good mechanical properties and comparatively high solids contents possible. Moreover, due to the uniform distribution of the carboxyl and/or carboxylate groups in the polyurethane polymer, only moderate charge densities are required for stabilizing the corresponding polyurethane dispersions.

In the reaction stage d), the polyurethane prepolymer from stage c) is mixed with a prefabricated mixture consisting of from 5 to 225 parts by weight of water, from 0.5 to 4 parts by weight of a neutralization component (D) and from 0 to 1.0 parts by weight of a defoamer component (E). The reaction stage d) is implemented at a preferred temperature of from 20 to 80° C., in particular from 40 to 60° C. According to a preferred embodiment, the neutralization component (D) is used in such an amount that the degree of neutralization, based on the free carboxyl groups of the polyurethane prepolymer, is from 70 to 100 equivalent-%, preferably from 80 to 100 equivalent-%. The neutralization component (D) is added in advance for the complete or partial neutralization of the carboxyl groups in the dispersing medium (indirect neutralization). During neutralization, carboxylate groups are formed from the carboxyl groups, which serve for the anionic modification and/or stabilization of the polyurethane dispersion. Alternatively, the polyurethane prepolymer from the reaction stage c) may possibly also be stirred into the prefabricated mixture of water, neutralization component (D) and defoamer component (E) or the neutralization component (D) may possibly also be stirred into the polyurethane prepolymer after the reaction stage c) (direct neutralization).

All cationic counter-ions to the anionic carboxylate groups are dissolved in the dispersing medium. The terms “dispersing” or “dispersion” include that, in addition to dispersed components with micellar structure, solvated and/or suspended components may be contained.

The neutralization component (D) with a moiety of from 0.5 to 4 parts by weight consists of one or several bases which serve for the complete or partial neutralization of the carboxyl groups. Tertiary amines such as N,N-dimethyl ethanol amine, N-methyl diethanol amine, triethanol amine, N,N-dimethyl isopropanol amine, N-methyl diisopropanol amine, triisopropyl amine, N-methyl morpholine, N-ethyl morpholine, triethyl amine or ammonia and alkali hydroxides (NaOH, KOH) can be used as suitable bases. Tertiary amines and in particular triethyl amine are preferably used.

The defoamer component (E) with a moiety of from 0 to 1 parts by weight consists of one or several defoamers that are customary for polyurethane dispersions, which serve for degassing (air, carbon dioxide) and counter-act foam formation. Hardened foam cannot be redispersed and, otherwise, deposits in the form of fine needles as precipitate. Suitable defoamers are e.g. products of the Tego Chemie Service GmbH company (types TEGO® Foamex 800 and 805) and of Byk Chemie GmbH company (type Byk-024).

After the theoretical total NCO content has been achieved, the polyurethane prepolymer is not dispersed in water as in the processes frequently described in patent literature, but, according to a preferred embodiment, is, at first, overlaid in the reaction vessel with a mixture of water, a neutralization component and a defoamer component without shearing forces and, finally, completely dispersed under intensive stirring with the aid of a dissolver within a few minutes. This procedure has the advantage that dispersing can be carried out in the reaction vessel itself and that it is extremely easy to process even polyurethane prepolymers of a high viscosity. Here, the polyurethane prepolymer is not introduced slowly into the dispersing medium, but overlaid with the entire amount of dispersing medium and then immediately stirred. Alternatively to this procedure, the polyurethane prepolymer from stage c) can be mixed into the prefabricated mixture of water, the neutralization component (D) and the defoamer component (E).

In the case of the use of identical formulations, the suggested process of multi-stage prepolymer synthesis and inverse process, as compared with the prepolymer mixing process, to polyurethane dispersions with somewhat higher solids content and improved mechanical properties. A further advantage of the dispersing method by means of overlaying the polyurethane prepolymer resin with the dispersing medium resides in the especially high efficiency with which the polyurethane prepolymer is completely brought into aqueous phase. Thus, no residue of polyurethane prepolymer remain in the reactor or the tubings and, consequently, cleaning is considerably facilitated.

In the reaction stage e), the polyurethane prepolymer dispersion from reaction stage d) is reacted with 0.025 to 4 parts by weight of a chain extender component (F). The reaction stage e) is implemented at a preferred temperature of from 20 to 80° C., in particular at from 30 to 50° C. According to a preferred embodiment, the chain extender component (F) is used in such an amount, that the degree of chain prolongation, based on the free isocyanate groups of the polyurethane prepolymer, is from 10 to 100 equivalent-%, preferably from 50 to 100 equivalent-%. In the reaction stage e), the chain extender component (F) is dissolved at a ratio of from 1:10 to 10:1 in moieties of the dispersing agent, which were withdrawn in advance and subsequently added. The chain prolongation of the polyurethane prepolymer dispersion results in the building up of the molecular weight within the micellae and in the formation of a polyurethane polyurea dispersion of a high molecular weight. Then, the chain extender component (F) reacts substantially more rapidly with the reactive isocyanate groups than water. Following the reaction stage e), free isocyanate groups which possibly are still present, may be completely chain-extended with water. Alternatively, the chain extender component (F) may possibly also already used in the reaction stage d) as a prefabricated mixture with water, the neutralization component (D) and the defoamer component (E).

The chain extender component (F) consists of at least one polyamine with two or more amino groups that are reactive to polyisocyanates. Suitable polyamines are e.g. adipic acid dihydrazide, ethylene diamine, diethylene triamine, triethylene tetraamine, tetraethylene pentamine, pentaethylene hexamine, dipropylene triamine, hexamethylene diamine, hyrazine, isophorone diamine, N-(2-aminoethyl)-2-amino ethanol, adducts of salts of 2-acrylamido-2-methylpropan-1-sulfonic acid (AMPS) and ethylene diamine, adducts of salts of (meth)acrylic acid and ethylene diamine or optional combinations of these polyamines. Difunctional, primary amines and, in particular, ethylene diamine are preferably used.

The processing time between the completion of stage c) and the completion of stage e) is preferably less than 1 hour, in particular less than 30 minutes.

All former products based on polyurethane can be replaced in the formulation of crack-sealing coating systems by means of the aqueous, isocyanate-free polyurethane dispersions suggested according to the invention.

The aqueous polyurethane dispersions suggested according to the invention are used in the production of formulations for crack-sealing coating systems as binding agent for

a) self-levelling primer, floating screed and cover coatings,

b) (possibly flame-proofed) spray coatings,

c) (possibly flame-proofed) light-fast and pigmented primer and cover layers and sealings,

d) one-component, pigmented and light-fast cover layers,

e) two-component, colorless and light-fast sealings,

f) two-component, pigmented and light-fast sealings.

According to an especially preferred embodiment the formulations suggested according to the invention contain from 25 to 99% by weight of aqueous polyurethane dispersions and from 15 to 50% by weight of polyurethane polymers.

In addition to the binding agent, fillers (also water-binding fillers such as cement), pigments, softeners, fiber materials, defoamers, dearation agents, slip additives and flow-control additives, dispersing additives, substrate wetting additives, hydrophobing agents, rheology additives, adhesives, flame-proofing agents, anti-freezing agent, matting agents, antioxidants, UV stabilizers, bactericides, fungicides and preservatives are used as formulation components. The production and application of the formulations is carried out with the methods known from the varnish and coating technologies and must not be further explained.

The formulations suggested according to the invention are used individually or in combination for the building up of the system for crack-sealing coating systems in the form of

a) coatings for top floors of parking areas and parking garages,

b) bridge and bridge crown sealings,

c) balcony coatings,

d) (possibly flame-proofed) sealings of flat roofs with cementous, metallic, bituminous or polymeric foundations or foundations

e) (possibly flame-proofed) UV protective coatings on weathered or new roof foam,

f) floor coverings for the interior (thick or thin coatings), and

g) building structure sealings under turfing.

Depending upon application and system structure, the formulations according to the invention on the basis of polyurethane dispersions may be applied onto the elastic or rigid foundations in layers with a total thickness of from 0.05 to 50 mm. For this, 0.1 to 10.0 kg of the formulations on the basis of polyurethane dispersions are required, as a rule, per m² of the surface to be coated and per operation.

Possibly, the chalking and permanent water resistance (hot water of approx. 50° C.) of formulations on the basis of polyurethane dispersions may be substantially increased by the use of UV stabilizers of the type of the sterically hindered amines in concentrations of from 0.1 to 5.0% by weight, based on the total mass of the formulation. It was possible to unequivocally prove this in a device especially conceived for this purpose in an extreme climate (intensive UV radiation, increased temperature, simultaneous sprinkling).

It was also possible to achieve a clear improvement in conventional (isocyanate-containing) coatings that were protected in the same fashion. The used UV stabilizers are systems of the HALS type (hindered amine light stabilizer) such as 1,2,2,6,6-pentamentyl-4-piperidinyl ester of decanedioic acid (HALS I) or 2,2,6,6-tetramethyl-1-isooctyloxy-4-piperidinylester of decanedioic acid (HALS II). HALS I types are preferably used. In combination with UV stabilizers of the HALS type, UV absorbers such as substituted hydroxy phenyl benzotriazoles, hydroxy benzophenones, hydroxyphenyl-s-triazines and antioxidants such as substituted 2,6-di-tert.-butyl phenols can also be additionally used.

Although the polyurethane dispersion formulated according to the invention can be used in a one- and two-component form, the one-component form is preferred due to the better handling capacity. In the case of a two-component application, the polyurethane dispersions formulated according to the invention are used as binding agent component (component A) and water-emulsifiable polyisocyanate, polyaziridines or other substances suitable for post-cross-linking are used as hardener component (component B). The mixing ratio of component A to component B must then be adapted to the respective requirements.

Moreover, it is basically also possible that polyurethane dispersions are combined with aqueous polymer dispersions, redispersible polymer powders and/or non-aqueous polymers within the formulations. Moreover, the formulations on the basis of polyurethane dispersions can be combined with formulations on the basis of aqueous polymer dispersions, redispersible polymer powders, aqueous reactive resins, non-aqueous polymers and/or non-aqueous reactive resins within the crack-sealing coating systems. The aqueous polymer dispersions are preferably solvent-free mixtures of polyurethane, polymer, hybrid with a solids content of from 40 to 60% by weight, which are described in the German patent application DE 199 49 971, and emulsion polymers on the basis of (meth)acrylic acid and derivatives and/or styrene and derivatives and/or further ethylenically unsaturated monomers. Solvent-free or solvent-containing, two-component epoxide resins and solvent-free or solvent-containing one-or two-component polyurethanes are preferably used as non-aqueous reactive resins, which are based on aliphatic or aromatic polyurethane prepolymers and which cure in the presence of air humidity or aliphatic or aromatic amines. Two-component, solvent-free or solvent-containing epoxide resins which are based on bisphenol A diglycide ether, bisphenol F diglycide ether and their derivatives and which cure in the presence of aliphatic or aromatic amines and one- or two-component polyurethanes or products based on a dispersion are in particular used as primers. In addition to this, further aliphatic or aromatic polyepoxides can also be used as cross-linking agents or reactive diluents. There is complete compatibility with optional arrangement in the system structure of crack-sealing coating systems between the formulations according to the invention and the formulations on the basis of solvent-free or solvent-containing one- or two-component polyurethanes, if the reworking times are observed.

Metal hydroxides, metal carbonate hydrates, metal oxide hydrates, polyatomic complex salts on the basis of aluminum, antimony, boron and zinc or isocyanurates, melamine resins, polyhydroxy compounds and inorganic or organic phosphates are preferably used as flame-proofing agents.

In addition to this improved processability and the very good environmental acceptability, the polyurethane dispersions suggested according to the invention make the following advantages product properties possible with respect to the corresponding formulations and the corresponding crack-sealing coating systems:

Coatings for Top Floors of Parking Areas and Parking Garages Bridge and Bridge Crown Sealings

Advantages as compared with the prior art:

Physiologically safe

isocyanate-free (exception: two-component sealing, weakly isocyanate-containing)

solvent-free (exception: two-component sealing, low solvent content)

amine-free

Use of one-component products (exception: two-component sealing)

No scattering of the epoxide resin priming necessary

Good curing at low temperatures (<10° C.); as a rule, isocyanate-containing formulations cure only slowly at low temperatures and only achieve a reduced property level due to side reactions

Complete compatibility of the formulations according to the invention to conventional formulations on the basis of one- and two-component polyurethanes.

Balcony Coatings

Advantages as compared with the prior art:

Physiologically safe

isocyanate-free (exception: two-component sealing, weakly isocyanate-containing)

low solvent content (small amounts of NMP and Proglyde DMM)

no strongly smelling split-off products from latent hardeners that are released over a longer period of time (e.g. isobutyraldehyde),

Use of one-component products (exception: two-component sealing)

No scattering of the epoxide resin priming necessary

Good curing at low temperatures (<10° C.);

As a rule, isocyanate-containing formulations cure only slowly at low temperatures and only achieve a reduced property level due to side reactions

Very rapid curing and reworkability of the applied aqueous formulations; system can be built in within a short period of time

(Possibly Flame-proofed) Sealings of Flat Roofs with Cementous, Metallic, Bituminous or Polymeric Foundations or Foundations

Advantages as compared with the prior art:

Physiologically safe

isocyanate-free (exception: two-component sealing, weakly isocyanate-containing)

low solvent content (small amounts of NMP)

no strongly smelling split-off products from latent hardeners that are released over a longer period of time (e.g. isobutyraldehyde),

Use of one-component products

Good curing at low temperatures (<10° C.); as a rule, isocyanate-containing formulations cure only slowly at low temperatures and only achieve a reduced property level due to side reactions

Color stability

(Possibly Flame-proofed) UV Protective Paints on Weathered and New Roof Foam

Advantages as compared with the prior art:

a) as compared with one-component PUR products:

Physiologically safe

isocyanate-free

low solvent content (small amounts of NMP)

no strongly smelling split-off products from latent hardeners that are released over a longer period of time (e.g. isobutyraldehyde),

b) as compared with one-component acrylate products:

better mechanical properties

very low water absorption

Thus, products on the basis of PUR dispersions combine the advantages of both product types used at present.

Floor Coverings for the Interior

Advantages as compared with the prior art:

Physiologically safe

isocyanate-free (exception: two-component sealing, weakly isocyanate-containing)

low solvent content (small amounts of NMP and Proglyde DMM)

no strongly smelling split-off products from latent hardeners that are released over a longer period of time (e.g. isobutyraldehyde),

Use of one-component products (exception: two-component sealing)

No scattering of the epoxide resin priming necessary

Very rapid curing and reworkability of the applied aqueous formulations; system can be built in within a short period of time

Building Structure Sealings under Turfing

Advantages as compared with the prior art:

Physiologically safe

isocyanate-free

solvent-free

can be processed both by machines and by hand

in particular no spraying of monomeric polyisocyanate (exceeding of the MAK value possible!)

Use of one-component products (no mixing errors)

Spraying with lesser expenditure than in the case of the reactive coating, since no two-component spraying machine is required.

No priming and no sand-blasting required

Two-component sealing (weakly isocyanate-containing and low solvent content) only as a demand item

General

The mechanical properties (tensile strength, elongation at tensile strength, elongation at break) of the formulations are, contrary to expectations, at least equal to, in general even clearly better than in conventional isocyanate-containing systems

All formulations show a very good UV and color stabilizing so that, possibly, a sealing can be renounced. Commercially customary, conventional, isocyanate-containing systems show a clearly lower UV and weathering resistance

The hydrolysis stability of the formulations is unexpectedly high also without a post-cross-linking

Unlimited adhesion within the individual layers of the aforementioned crack-sealing coating systems is given

As compared with conventional isocyanate-containing systems, a higher color brilliance with a lesser tendency to chalking is given

Formulations for crack-sealing coating systems were outdoor-processed. It was possible to assess durability, layer adhesion, resistance to V, water resistance weathering resistance, etc. in reality. The results obtained in the laboratory were confirmed.

The following examples are to illustrate the invention in greater detail.

### EXAMPLES A.1 to A.4:

### Polyurethane Dispersions

Example A.1

Solvent-free Polyurethane Dispersion

(basis: polypropylene glycol having a molecular weight of 2,000 daltons)

A mixture of 703.1 g polypropylene glycol with a hydroxyl number of 56.1 mg KOH g⁻¹ (trade name Arco Acclaim® 2200 of Arco Chemical company) and 249.5 g isophorone diisocyanate (trade name Desmodur I of Bayer company) under nitrogen were stirred in a four-neck flask provided with a KPG stirrer, a reflux condenser, a thermometer and a nitrogen atmosphere for 2 hours at 80 to 90° C. in the presence of 0.2 g dibutyl tin dilaureate (DBTL) as a catalyst. After the addition of 28.1 g finely ground dimethylol propionic acid (trade name DMPA® of the Mallinckrodt company) to the polyurethane preadduct, the mixture is further stirred under nitrogen at 80 to 90° C., until the calculated NCO content is achieved (theory: 4.81% by weight of NCO). The course of the reaction is acidimetrically followed. After cooling to 60° C., the polyurethane prepolymer is neutralized with 19.1 g triethyl amine. 1000.0 g of the polyurethane prepolymer are then dispersed in 1000.0 water with intensive stirring and subsequently chain-extended with 54.0 g aqueous ethylene diamine solution (50% by weight).

A stable polyurethane dispersion with the following characteristics is obtained:

| | |
|---|---|
| Appearance | Milky-white liquid |
| Solids content | 50% by weight |
| Tensile strength | 23.6 MPa |
| Elongation at tensile strength | 705% |
| Elongation at break | 705% |
| Hardness according to König | 25 s |

Example A.2

Solvent-free Polyurethane Solution

(Basis: polypropylene glycol having a molecular weight of 2,000 daltons)

A mixture of 703.1 g polypropylene glycol with a hydroxyl number of 56.1 mg KOH g⁻¹ (trade name Arco Acclaim® 2200 of Arco Chemical company) and 249.5 g isophorone diisocyanate (trade name Desmodur I of Bayer company) under nitrogen were stirred in a four-neck flask provided with a KPG stirrer, a reflux condenser, a thermometer and a nitrogen atmosphere for 2 hours at 80 to 90° C. in the presence of 0.2 g dibutyl tin dilaureate (DBTL) as a catalyst. After the addition of 28.1 g finely ground dimethylol propionic acid (trade name DMPA® of the Mallinckrodt company) to the polyurethane preadduct, the mixture is further stirred under nitrogen at 80 to 90° C., until the calculated NCO content is achieved (theory: 4.81% by weight of NCO). The course of the reaction is acidimetrically followed. After cooling to 60° C., the polyurethane prepolymer is neutralized with 19.1 g triethyl amine. 1000.0 g of the polyurethane prepolymer are then dispersed in 813.2 g water with intensive stirring and subsequently chain-extended with 54.0 g aqueous ethylene diamine solution (50% by weight).

A stable polyurethane dispersion with the following characteristics is obtained:

| | |
|---|---|
| Appearance | Milky-white liquid |
| Solids content | 55% by weight |
| Tensile strength | 23.6 MPa |
| Elongation at tensile strength | 705% |
| Elongation at break | 705% |
| Hardness according to König | 25 s |

Example A.3

Low-solvent and Light-fast Polyurethane Dispersion

(Basis: polycarbonate polyol having a molecular weight of 2,000 daltons)

A mixture of 604.2 g polycarbonate polyol with a hydroxyl number of 56.1 mg KOH·g⁻¹ (trade name Desmodur® C 200 of Bayer company) and 247.0 g isophorone diisocyanate (trade name Desmodur I of Bayer company) and 91.5 g N-methyl pyrrolidone under nitrogen were stirred in a four-neck flask provided with a KPG stirrer, a reflux condenser, a thermometer and a nitrogen atmosphere for 2 hours at 80 to 90° C. in the presence of 0.2 g dibutyl tin dilaureate (DBTL) as a catalyst. After the addition of 34.0 g finely ground dimethylol propionic acid (trade name DMPA® of the Mallinckrodt company) to the polyurethane preadduct, the mixture is further stirred under nitrogen at 80 to 90° C., until the calculated NCO content is achieved (theory: 4.78% by weight of NCO). The course of the reaction is acidimetrically followed. After cooling to 60° C., the polyurethane prepolymer is neutralized with 23.1 g triethyl amine. 1000.0 g of the polyurethane prepolymer are then overlaid with 817.0 g water without stirring, subsequently completely dispersed under intensive stirring within a few minutes and then chain-extended with 50.8 g aqueous ethylene diamine solution (50% by weight).

A stable polyurethane dispersion with the following characteristics is obtained:

| | |
|---|---|
| Appearance | Milky-white liquid |
| Solids content | 50.0% by weight |
| Solvent content | 4.9% by weight |
| Tensile strength | 28.5 MPa |
| Elongation at tensile strength | 300% |
| Elongation at break | 300% |
| Hardness according to König | 50 s |

Example A.4

Low-solvent and Light-fast Polyurethane Dispersion

(Basis: polycarbonate polyol having a molecular weight of 2,000 daltons)

327.2 g of a premix consisting of 497.0 g polycarbonate polyol with a hydroxyl number of 56.1 mg KOH·g⁻¹ (trade name Desmodur® C 200 of Bayer company), 22.4 g 1,4-butane diol, 40.0 g finely ground dimethylol propionic acid (trade name DMPA® of the Mallinckrodt company) and 95.0 g N-methyl pyrrolidone and 318.2 g isophorone diisocyanate (trade name Desmodur I of Bayer company) under nitrogen were stirred in a four-neck flask provided with a KPG stirrer, a reflux condenser, a thermometer and a nitrogen atmosphere for 2 hours at 80 to 90° C. in the presence of 0.2 g dibutyl tin dilaureate (DBTL) as a catalyst. After the addition of the remaining 327.2 g of the premix to the polyurethane preadduct, the mixture is further stirred under nitrogen at 80 to 90° C., until the calculated NCO content is achieved (theory: 5.50% by weight of NCO). The course of the reaction is acidimetrically followed. After cooling to 60° C., the polyurethane prepolymer is neutralized with 27.2 g triethyl amine. 1000.0 g of the polyurethane prepolymer are then overlaid with 1017.9 g water without stirring, subsequently completely dispersed under intensive stirring within a few minutes and then chain-extended with 61.2 g aqueous ethylene diamine solution (50% by weight).

A stable polyurethane dispersion with the following characteristics is obtained:

| | |
|---|---|
| Appearance | Milky-white liquid |
| Solids content | 45.0% by weight |
| Solvent content | 4.6% by weight |
| Tensile strength | 25 MPa |
| Elongation at tensile strength | 260% |
| Elongation at break | 260% |
| Hardness according to König | 65 s |

### EXAMPLES B.1 to B.6

### Formulations

The indicates refer in each case to parts by weight

PUD=polyurethane dispersion

Example B.1

Self-levelling Primer/Cover Layer/Floating Screed

(1) 648.0 PUD according to example A.1

(2) 2.0 Byk-024 (mixture of defoaming polysiloxanes)

(3) 2.0 Byk-022 (mixture of defoaming polysiloxanes)

(4) 3.0 Disperbyk-190 (block copolymer with pigment-affine groups)

(5) 20.0 Heucosin RAL 7032 (pigment)

(6) 3.0 Tego Wet 265 (substrate wetting additive)

(7) 311.0 Millicarb (filler, natural calcium carbonat)

(8) 5.0 Aerosil 200 (pyrogenic silicid acid)

(9) 1.0 Tafigel PUR 60 (polyurethane thickening agent)

(10) 3.0 Irganox 1135 (antioxidant)

(11) 2.0 Edaplan LA 413 (silicone flow improver additive)

Σ:1000.0

| Tensile strength | 10.3 MPa |
|---|---|
| Elongation at break | 560% |

Example B.2

Flame-proofed Spray Coating

(1) 485.9 PUD according to example A.2

(2) 2.0 Byk-024 (mixture of defoaming polysiloxanes)

(3) 2.0 pigment disperser NL (ammonium salt of a polyacrylate)

(4) 5.0 Bayferrox 130 (pigment)

(5) 110.5 Omyacarb 10 BG (filler, natural calcium carbonate)

(6) 380.0 Apyral 16 (flame-retardant filler, aluminum hydroxide)

(7) 0.6 Tafigel PUR 45 (polyurethane thickening agent)

(8) 1.0 Tafigel PUR 60 (polyurethane thickening agent)

(9) 10.0 Metatin 55-45 (biocide)

(10) 3.0 Irganox 1135 (antioxidant)

Σ:1000.0

| | |
|---|---|
| Tensile strength | 5.8 MPa |
| Elongation at break | 350% |
| Water absorption | approx. 5% by weight |

Example B.3

Flame-proofed, Light-fast and Pigmented Primer/Cover Layer/Sealing

(1) 393.2 PUD according to example A.3 (light-fast)

(2) 75.0 Acronal S 321 (styrene/acrylate copolymer dispersion)

(3) 5.0 Byk-028 (mixture of defoaming polysiloxanes)

(4) 3.0 Disperbyk-190 (block copolymer with pigment-affine groups)

(5) 3.0 Tego Wet 500 (foam-inhibiting wetting additive)

(6) 55.0 Disflamoll DPK (phosphate softener with flame-proofing)

(7) 75.0 Bayferrox 130 (pigment)

(8) 340.0 Securoc A 32 (flame-inhibiting filler, aluminum hydroxide)

(9) 2.0 Edaplan LA 413 (silicone flow improver additive)

(10) 15.0 Metatin 55-45 (biocide)

(11) 30.0 water

(12) 0.5 Tafigel PUR 45 (polyurethane thickening agent)

(13) 0.3 Tafigel PUR 60 (polyurethane thickening agent)

(14) 3.0 Tiuvin 292 (light-stability agent, HALS type)

Σ:1000.0

| | |
|---|---|
| Tensile strength | 2.8 MPa |
| Elongation at break | 277% |
| Water absorption (1 d) | 6.3% by weight |
| Water absorption (5 d) | 2.3% by weight |

Example B.4

One-component, Pigmented and Light-fast Cover Layer

(1) 784.0 PUD according to example A.4 (light-fast)

(2) 8.0 Byk-024 (mixture of defoaming polysiloxanes)

(3) 5.0 Disperbyk-191 (block copolymer with pigment-affine groups

(4) 5.0 Tego Wet 500 (foam-inhibiting wetting additive)

(5) 70.0 Heucosin RAL 7032 (pigment)

(6) 120.0 Silitin Z 89 (silica, mixture of quartz and kaolinite)

(7) 2.0 Aerosil 200 (pyrogenic silicic acid)

(8) 3.0 Edaplan LA 413 (silicone flow improver additive)

(9) 3.0 Tinuvin 292 (light-stabilizer, HALS type)

Σ:1000.0

| Density | 1.2 kg dm⁻³ |
|---|---|
| Solids content | approx. 55% by weight |
| Viscosity | approx. 500 mPa s |
| Tensile strength | 25 MPa |
| Elongation at break | 280% |

Example B.5

Two-component, Colorless and Light-fast Sealing

Component A (binding agent)

(1) 988.0 PUD according to example A.4 (light-fast)

(2) 3.0 Byk-024 (mixture of defoaming polysiloxanes)

(3) 3.0 Tego Wet 500 (foam-inhibiting wetting additive)

(4) 3.0 Edaplan LA 413 (silicone flow improver additive)

(5) 3.0 Tinuvin 292 (light-stabilizer, HALS type)

Σ:1000.0

Component B (hardening agent)

(1) 900.0 Basonat PLR 8878 (water-dispersible polyisocyanate)

(2) 100.0 Proglyde DMM (dipropylene glycol dimethyl ether, solvent)

Σ:1000.0

Mixing ratio: A:B=1000:180 parts by weight

| | |
|---|---|
| Density (23° C.) | 1.2 kg dm⁻³ |
| Solids content | approx. 50% by weight |
| Viscosity | 45 s |
| (4 mm DIN cup) | |
| Passability (23°) C. | 2 hours |
| Chemically loadable (23° C.) | 7 d |

Example B.6

Two-component, Pigmented and Light-fast Sealing

Component A (binding agent)

(1) 700.0 PUD according to example A.4 (light-fast)

(2) 3.0 Byk-011 (mixture of defoaming polysiloxanes)

(3) 3.0 Disperbyk-190 (block copolymer and pigment-affine groups

(4) 170.0 Heucosin RAL 7032 pebble gray (pigment)

(5) 76.0 Silitin Z 89 (silica, mixture of quartz and kaolinite)

(6) 2.0 Aerosil 200 (pyrogenic silicic acid)

(7) 2.0 Byk-022 (mixture of defoaming polysiloxanes)

(8) 4.0 Byk-333 (flow improving additive, on the basis of silicone)

(9) 2.0 Tafigel PUR 45 (polyurethane thickening agent)

(10) 30.0 Water

Σ:1000.0

Component B (hardening agent)

(1) 900.0 Rhodocoat WT 2102 (water-dispersible polyisocyanate)

(2) 100.0 Proglyde DMM (dipropylene glycol dimethyl ether, solvent)

Σ:1000.0

Mixing ratio: A:B=1000:150 parts by weight

### EXAMPLES C.1 to C.14

### Crack-sealing Coating Systems

EP=epoxide resin

PUD=polyurethane dispersion

PUR=conventional polyurethane resin

Example C.1

System Structure I in Accordance with OS 11 for Coatings for Top Floors of Parking Areas and Parking Garages

System Structure for Bridges and Bridge Crowns

| | | |
|---|---|---|
| Primer | Conipox 77 Z | Consumption |
| | transparent | approx. 1.0 kg · m⁻² |
| | EP, two-component | |
| | solvent-free | |
| | 1:0.8 filled with fire-dried | |
| | quartz sand of the | |
| | graining 0.05 to 0.20 mm | |
| 1st floating | Formulation according to | Consumption |
| screed | Example B.1 | approx. 1.0 kg · m⁻² |
| | pigmented | |
| | PUD, one-component | |
| | solvent-free | |
| 2nd floating | Formulation according to | Consumption |
| screed | Example B.1 | approx. 1.0 kg · m⁻² |
| | pigmented | |
| | PUD, one-component | |
| | solvent-free | |
| Cover layer | Formulation according to | Consumption |
| | Example B.1 | approx. 2.5 kg · m⁻² |
| | pigmented | |
| | PUD, one-component | |
| | solvent-free | |
| | 1:0.9, filled with fire-dried | |
| | quartz sand of the graining | |
| | 0.05-0.20 mm | |
| | excessive sanding | Consumption |
| | fire-dried quartz sand | approx. 2.5 kg · m⁻² |
| | of the graining 0.3-0.8 mm | |
| Sealing | Formulation according to | Consumption |
| | Example B.6 | approx. 0.60 kg · m⁻² |
| | pigmented | |
| | PUD, two-component | |
| | low solvent content | |

Example C.2

System Structure II in Accordance with OS 13 for Coatings for Top Floors of Parking Areas and Parking Garages

System Structure for Bridges and Bridge Crowns

| | | |
|---|---|---|
| Primer | Conipox 77 Z | Consumption |
| | transparent | approx. 1.0 kg · m⁻² |
| | EP, two-component | |
| | solvent-free | |
| | 1:0.8 filled with fire-dried | |
| | quartz sand of the | |
| | graining 0.05 to 0.20 mm | |
| 1st cover layer | Formulation according to | Consumption |
| | Example B.1 | approx. 2.5 kg · m⁻² |
| | pigmented | |
| | PUD, one-component | |
| | solvent-free | |
| | 1:0.9 filled with fire-dried | |
| | quartz sand of the graining | |
| | 0.05 to 0.20 mm | |
| 2nd cover layer | Formulation according to | Consumption |
| | Example B.1 | approx. 2.5 kg · m⁻² |
| | pigmented | |
| | PUD, one-component | |
| | solvent-free | |
| | 1:0.9 filled with fire-dried | |
| | quartz sand of the | |
| | graining 0.05 to 0.20 mm | |
| | excessive sanding | Consumption |
| | fire-dried quartz sand of the | approx. 2.5 kg · m⁻² |
| | graining 0.3-0.8 mm | |
| Sealing | Formulation according to | Consumption |
| | Example B.6 | approx. 0.60 kg · m⁻² |
| | pigmented | |
| | PUD, two-component | |
| | low solvent content | |

Example C.3

System Structure III in Accordance with OS 13 for Coatings for Top Floors of Parking Areas and Parking Garages

System Structure for Bridges and Bridge Crowns

| | | |
|---|---|---|
| Primer | Conipox 77 Z | Consumption |
| | transparent | approx. 0.4 kg · m⁻² |
| | EP, two-component | |
| | solvent-free | |
| Cover layer | Formulation according to | Consumption |
| | Example B.1 | approx. 2.5 kg · m⁻² |
| | pigmented | |
| | PUD, one-component | |
| | solvent-free | |
| | 1:0.9 filled with fire-dried | |
| | quartz sand of the graining | |
| | 0.05 to 0.20 mm | |
| | excessive sanding | Consumption |
| | fire-dried quartz sand of the | approx. 2.5 kg · m⁻² |
| | graining 0.3-0.8 mm | |
| Sealing | Formulation according to | Consumption |
| | Example B.6 | approx. 0.60 kg · m⁻² |
| | pigmented | |
| | PUD, two-component | |
| | low solvent content | |

Example C.4

System Structure IV in Accordance with ZTV-SIB OS-F for Coatings for Top Floors of Parking Areas and Parking Garages

System Structure for Bridges and Bridge Crowns

| | | |
|---|---|---|
| Primer | Conipox 77 Z | Consumption |
| | transparent | approx. 1.0 kg · m⁻² |
| | EP, two-component | |
| | solvent-free | |
| | 1:0.9 filled with fire-dried | |
| | quartz sand of the graining | |
| | 0.05 to 0.20 mm | |
| Spray coating | Formulation according to | Consumption |
| | Example B.2 | approx. 2.5 kg · m⁻² |
| | pigmented | |
| | PUD, one-component | |
| | solvent-free | |
| Cover layer | Formulation according to | Consumption |
| | Example B.1 | approx. 2.5 kg · m⁻² |
| | pigmented | |
| | PUD, one-component | |
| | solvent-free | |
| | 1:0.9 filled with fire-dried | |
| | quartz sand of the graining | |
| | 0.05 to 0.20 mm | |
| | excessive sanding | Consumption |
| | fire-dried quartz sand of the | approx. 2.5 kg · m⁻² |
| | graining 0.3-0.8 mm | |
| Sealing | Formulation according to | Consumption |
| | Example B.6 | approx. 0.60 kg · m⁻² |
| | pigmented | |
| | PUD, two-component | |
| | low solvent content | |

Example C.5

Mixed System Structures Made from Formulations According to the Invention and Conventional Formulations as an Alternative

a) Alternative to example C.1 (sealing is omitted)

| | | |
|---|---|---|
| 1st + | CONIPUR 268 F | Consumption |
| 2nd floating screed | (Conica Technik AG) | approx. 2.1-2.5 kg · m⁻² |
| layer | pigmented | |
| | PUR, two-component | |
| | solvent-free | |
| | or | |
| Cover layer | CONIPUR 258 | Consumption |
| | (Conica Technik AG) | approx. 0.5-0.8 kg · m⁻² |
| | pigmented | |
| | PUR, one-component | |
| | low solvent content | |
| | abrasion-resistant, | |
| | viscoplastic, | |
| | dull, chemical-resistant, | |
| | UV resistant | |

b) Alternative to example B.2 (sealing is omitted)

| | | |
|---|---|---|
| 2nd cover layer | CONIPUR 258 | Consumption |
| | (Conica Technik AG) | approx. 0.5-0.8 kg · m⁻² |
| | pigmented | |
| | PUR, one-component | |
| | low solvent content | |
| | abrasion-resistant, | |
| | viscoplastic, | |
| | dull, chemical-resistant, | |
| | UV resistant | |

c) Alternative to example C.3 (sealing is omitted)

| | | |
|---|---|---|
| Cover layer | CONIPUR 258 | Consumption |
| | (Conica Technik AG) | approx. 0.5-0.8 kg · m⁻² |
| | pigmented | |
| | PUR, one-component | |
| | low solvent content | |
| | abrasion-resistant, | |
| | viscoplastic, | |
| | dull, chemical-resistant, | |
| | UV resistant | |

Example C.6

System Structure for Balcony Coating

| | | |
|---|---|---|
| Primer | Conipox 602 | Consumption |
| | transparent | approx. 1.0 kg |
| | EP, two-component | |
| | solvent-free | |
| | 1:0.8 filled with fire-dried | |
| | quartz sand of the | |
| | graining 0.05 to 0.20 mm | |
| 1st cover layer | Formulation according to | Consumption |
| | Example B.4 | approx. 0.3-0.4 kg · m⁻² |
| | pigmented | |
| | PUD, one-component | |
| | solvent-free | |
| 2nd cover layer | Formulation according to | Consumption |
| | Example B.4 | approx. 0.3-0.4 kg · m⁻² |
| | pigmented | |
| | PUD, one-component | |
| | solvent-free | |
| | scattering with colored chips | Consumption approx. |
| | (demand item) | 15-20 g · m⁻² |
| Sealing | Formulation according to | Consumption |
| | Example B.6 | approx. 0.15 kg · m⁻² |
| | pigmented | |
| | PUD, two-component | |
| | low solvent content | |
| | or | |
| | Formulation according to | |
| | example B.5 colorless | |
| | (upon scattering with colored | |
| | chips) | |
| | PUD, two-component | |
| | low solvent content | |

Example C.7

System Structure for Flame-proofed Sealing of Flat Roofs with Different Foundations (Cementous, Metallic, Bituminous Foundations and Foundations with Rigid Foams and PVC)

| | | |
|---|---|---|
| Spray coating | Formulation according to | Consumption |
| | Example B.2 | approx. 2.5 kg · m⁻² |
| | pigmented | |
| | PUD, one-component | |
| | solvent-free | |
| Sealing | Formulation according to | Consumption |
| | Example B.3 | approx. 0.15 kg · m⁻² |
| | pigmented | |
| | PUD, one-component | |
| | low solvent content | |
| | UV resistant | |

Application of the formulation according to example B.3 by means of rolling, spreading or spraying.

Example C.8

System Structure for Flame-proof UV Protective Paint on Weathered Roof Foam

| | | |
|---|---|---|
| Primer | Formulation according to | Consumption |
| | example B.3 | approx. 0.5-1.0 kg · m⁻² |
| | pigmented | |
| | PUD, one-component | |
| | low solvent content | |
| Cover layer | Formulation according to | Consumption |
| | Example B.3 | approx. 0.3-0.6 kg · m⁻² |
| | pigmented | |
| | PUD, one-component | |
| | low solvent content | |

Application of the formulation according to example B.3 by means of rolling, spreading or spraying.

Example C.9

System Structure for Flame-proofed UV Protective Paint on New Roof Foam

| | | |
|---|---|---|
| Primer | Formulation according to | Consumption |
| | example B.3 | approx. 0.30 kg · m⁻² |
| | pigmented | |
| | PUD, one-component | |
| | low solvent content | |
| Cover layer | Formulation according to | Consumption |
| | Example B.3 | approx. 0.30 kg · m⁻² |
| | pigmented | |
| | PUD, one-component | |
| | low solvent content | |

Application of the formulation according to example B.3 by means of rolling, spreading or spraying.

Example C.10

System Structure for Flame-proofs UV Protective Paint on New Roof Foam (Scattered Variant Resistant to Pecking by Birds)

| | | |
|---|---|---|
| Cover layer | Formulation according to | Consumption |
| | Example B.3 | approx. 0.80 kg · m⁻² |
| | pigmented | |
| | PUD, one-component | |
| | low solvent content | |
| | Scattering with | Consumption |
| | BA color slate of the | approx. 2.0 kg · m⁻² |
| | graining 2-3 mm | |
| | Basermann Minerals GmbH | |

Application of the formulation according to example B.3 by means of rolling, spreading or spraying.

Example C.11

System Structure for Flame-proofed UV Protective Paint on New Roof Foam (Scattered Variant Resistant to Pecking by Birds with Increased Crack-sealing)

| | | |
|---|---|---|
| Primer | Formulation according to | Consumption |
| | example B.3 | approx. 0.30 kg · m⁻² |
| | pigmented | |
| | PUD, one-component | |
| | low solvent content | |
| Cover layer | Formulation according to | Consumption |
| | Example B.3 | approx. 0.60 kg · m⁻² |
| | pigmented | |
| | PUD, one-component | |
| | low solvent content | |
| | Scattering with | Consumption |
| | BA color slate of the | approx. 2.0 kg · m⁻² |
| | graining 2-3 mm | |
| | Basermann Minerals GmbH | |

Application of the formulation according to example B.3 by means of rolling, spreading or spraying.

Example C.12

System Structure for Floor Coatings for Offices, Hospitals, etc. (Thin Coating)

| | | |
|---|---|---|
| Primer | Conipox 602 | Consumption |
| | transparent | approx. 1.0 kg · m⁻² |
| | ER two-component | |
| | solvent-free | |
| | 1:0.8 filled with fire-dried | |
| | quartz sand of the | |
| | graining 0.05 to 0.20 mm | |
| 1st cover layer | Formulation according to | Consumption |
| | Example B.4 | approx. 0.3-0.4 kg · m⁻² |
| | pigmented | |
| | PUD, one-component | |
| | low solvent content | |
| 2nd cover layer | Formulation according to | Consumption |
| | Example B.4 | approx. 0.3-0.4 kg · m⁻² |
| | pigmented | |
| | PUD, one-component | |
| | low solvent content | |
| | scattering with colored chips | Consumption approx. |
| | (demand item) | 15-20 g · m⁻² |
| Sealing | Formulation according to | Consumption |
| | Example B.6 | approx. 0.15 kg · m⁻² |
| | pigmented | |
| | PUD, two-component | |
| | low solvent content | |
| | or | |
| | Formulation according to | |
| | example B.5 colorless | |
| | (upon scattering with colored | |
| | chips) | |
| | PUD, two-component | |
| | low solvent content | |

Example C.13

System Structure for Floor Coatings for Offices, Hospitals, etc. (Thick Coating)

| | | |
|---|---|---|
| Primer | Conipox 602 | Consumption |
| | transparent | approx. 1.0 kg · m⁻² |
| | EP, two-component | |
| | solvent-free | |
| | 1:0.8 filled with fire-dried | |
| | quartz sand of the | |
| | graining 0.05 to 0.20 mm | |
| Primer | Formulation according to | Consumption |
| | example B.1 | approx. 2.0 kg · m⁻² |
| | transparent | |
| | PUD, one-component | |
| | solvent-free | |
| | 1:0.9 filled with fire-dried | |
| | quartz sand of the | |
| | graining 0.05 to 0.20 mm | |
| Cover layer | Formulation according to | Consumption |
| | Example B.4 | approx. 0.3-0.4 kg · m⁻² |
| | pigmented | |
| | PUD, one-component | |
| | low solvent content | |
| | (demand item) | |
| | scattering with colored chips | Consumption approx. |
| | (demand item) | 15-20 g · m⁻² |
| Sealing | Formulation according to | Consumption |
| | Example B.6 | approx. 0.15 kg · m⁻² |
| | pigmented | |
| | PUD two-component | |
| | low solvent content | |
| | or | |
| | Formulation according to | |
| | example B.5 colorless | |
| | (upon scattering with colored | |
| | chips) | |
| | PUD, two-component | |
| | low solvent content | |

Example C.14

System Structure for Sealings Under Turfing and in Overground and Underground Construction

| | | |
|---|---|---|
| Spray coating | Formulation according to | Consumption |
| | Example B.2 | approx. 2-5 kg · m⁻² |
| | pigmented | |
| | PUD, one-component | |
| | solvent-free | |
| Sealing | Formulation according to | Consumption |
| | Example B.3 | approx. 0.3 kg · m⁻² |
| | pigmented | |
| | PUD, one-component | |
| | solvent-free | |
| | UV resistant | |
| | (demand item) | |

Application of the formulation according to example B.3 by means of rolling, spreading or spraying.

1. Use of aqueous, isocyanate-free polyurethane dispersions with a solids content of ≧30% by weight and a solvent content of ≦10% by weight in formulations for crack-sealing coating systems, which are selected from:
a) primer, floating screed, cover layers, spray coatings and/or sealings on preferably primed building surfaces,
b) roof coatings or paints, and
c) sealings of building structures in overground and underground construction.

2. Use according to claim 1, characterized in that the polyurethane dispersions are used as binding agents for
a) self-levelling primer, floating screed and cover coatings,
b) spray coatings,
c) light-fast and/or pigmented primer or cover layers or sealings,
d) one-component, pigmented or light-fast cover layers,
e) two-component, colorless or light-fast sealings,
f) two-component, pigmented or light-fast sealings.

3. Use according to claims 1 or 2, characterized in that the formulations are used individually or in combination as crack-sealing coating systems for the system structure of
a) coatings for top floors of parking areas and/or parking garages,
b) bridge and/or bridge crown sealings,
c) balcony coatings,
d) sealings of flat roofs with cementous, metallic, bituminous or polymeric foundations and foundations,
e) UV protective coatings on weathered or new roof foam,
f) floor coverings for the interior or
g) building structure sealings under turfing.

4. Use according to claims 1 to 3, characterized in that the polyurethane dispersions have a solids content of 40 to 60% by weight.

5. Use according to claims 1 to 4, characterized in that the formulations are applied onto the surfaces to be coated in layers with a total thickness of from 0.05 to 50 mm.

6. Use according to claims 1 to 5, characterized in that the formulations are used in an amount of from 0.1 to 10.0 kg·m⁻² of the surface to be coated and per operational step.

7. Use according to claims 1 to 6, characterized in that the formulations contain from 25 to 99% by weight of aqueous polyurethane dispersions.

8. Use according to claims 1 to 7, characterized in that the formulations contain from 15 to 50% by weight of polyurethane polymers.

9. Use according to claims 1 to 8, characterized in that the formulations contain 0.1 to 5.0% by weight, based on the total weight of the formulation, of an UV stabilizer on the basis of a sterically hindered amine.

10. Use according to claims 1 to 9, characterized in that the formulations are used in a one- or two-component form.

11. Use according to claims 1 to 10, characterized in that, in the case of a two-component application, the formulations on the basis of polyurethane dispersions are used as a binding agent component and water-emulsifiable polyisocyanates, polyaziridines, or other substances suited for post-cross-linking are used as the hardener component.

12. Use according to claims 1 to 11, characterized in that polyurethane dispersions are combined with aqueous polymer dispersions, redispersible polymer powders and/or non-aqueous polymers within the formulations.

13. Use according to claims 1 to 12, characterized in that the formulations on the basis of the polyurethane dispersions are combined with formulations on the basis of aqueous polymer dispersions, redispersible polymer powders, aqueous reactive resins, non-aqueous polymers and/or non-aqueous reactive resins.

14. Use according to claims 12 and 13, characterized in that solvent-free polyurethane polymer hybrid dispersions with a solids content of from 40 to 60% by weight are used as aqueous polymer dispersions.

15. Use according to claim 13, characterized in that solvent-free or solvent-containing, one- or two-component polyurethanes are used as non-aqueous reactive resins.

16. Use according to claim 15, characterized in that the one- or two-component polyurethanes are based on aliphatic or aromatic polyurethane prepolymers and cure in the presence of air humidity or aliphatic or aromatic amines.

17. Use according to claims 12 and 13, characterized in that emulsion polymers on the basis of (meth)acrylic acid and derivatives and/or styrene and derivatives and/or further ethylenically unsaturated monomers are used as aqueous polymer dispersions.

18. Use according to claims 1 to 17, characterized in that solvent-free or solvent-containing two-component epoxide resins, one- or two-component polyurethanes or products based on dispersions are used as primers.

19. Use according to claim 18, characterized in that bisphenol A diglycide ether, bisphenol F diglycide ether and their derivatives, which cure in the presence of aliphatic or aromatic amines, are used as two-component epoxide resins.
